(19) United States
(12) Patent Application Publication
(10) Pub. No.: US 2015/0228172 A1
(43) Pub. Date: Aug. 13, 2015

(54) INTEGRATED CHILD CAR SEAT ALARM

(71) Applicants: Patricia DeZur - Ahola, Montreal, WI (US); Ashley E. Howell, Montreal, WI (US)

(72) Inventors: Patricia DeZur - Ahola, Montreal, WI (US); Ashley E. Howell, Montreal, WI (US)

(21) Appl. No.: 14/178,638

(22) Filed: Feb. 12, 2014

(51) Int. Cl. G08B 21/02

(52) U.S. Cl. CPC G08B 21/02

(57) ABSTRACT

An integrated car seat alarm system for alerting a vehicle operator or those in the vicinity of a vehicle of a child being left in the car seat. The integrated car seat alarm system comprises a base car seat having a temperature sensing pad, a weight sensing pad, a transceiver assembly , and a temperature sensing strip, as well as a key fob having a fob body, a speaker, and an LED light. When it is determined that a child is present in the car seat and the temperature is in a unsafe range, an alarm signal is transmitted to the key fob and to the vehicle alarm system. This causes both the key fob to generate a audible alarm and a flashing light and the vehicle alarm system to go off until no child is sensed in the car seat.

### BACKGROUND OF THE INVENTION

1. Field of the Invention

This invention relates generally to child car seats and, more particularly, to a heat sensitive alarm system integrated into a child car seat and a vehicle alarm system.

2. Description of the Prior Art

The use of infant or child car seats to provide secure seating for a baby or small child while being transported in a vehicle is well known. Child car seats are typically structured to allow a child in a certain size ranged to be placed and seated thereon, and secured thereto through straps, buckles and/or belts. The child car seat is additionally secured in the vehicle through straps, buckles and/or belts. Such child car seats are customarily designed to protect the child thereon from injury during a vehicle collision.

A problem which still exists, however, is that children have been left in car seats by parents or caregivers of a child after the parent or caregiver exits the vehicle. Indeed, it is understood that the stress of modern living can effect focus and even make the most careful individuals absent minded. But when a child is left in a car seat, particularly on warm and/or sunny days, such a error can quickly become a deadly mistake. Since 1998, over 580 children have died after being left in hot cars. And this problem is not one that is likely to just go away—in just 2013, over twenty children have perished from heat exposure after being left in a car. Thus, there remains a need for an integrated child car seat alarm would alert a caregiver if a child is left in a car seat through a key fob. It would be helpful if such an integrated car seat alarm included temperature and weight sensors to determine when a child had been left in a car seat. It would be additionally desirable for such an integrated car seat alarm to be integrated with the vehicle alarm system to be able to alert anyone in the vicinity of a child stuck in a car seat of a hot car.

The Applicant's invention described herein provides for a car seat alarm system adapted to be built into the car seat and integrated with the vehicle alarm. The primary components of Applicant's integrated child car seat alarm are a temperature sensor, a weight sensor, transceiver assembly and a key fob receiver. When in operation, the car seat alarm alerts a vehicle operator, and anyone in the vicinity of a vehicle, when a child has been left in a car seat in a car with a dangerously high temperature. As a result, many of the problems seen with prior art car seat structures bars are removed.

### SUMMARY OF THE INVENTION

An integrated car seat alarm system for alerting a vehicle operator or those in the vicinity of a vehicle of a child being left in the car seat. The integrated car seat alarm system comprises a base car seat having a temperature sensing pad, a weight sensing pad, a transceiver assembly , and a temperature sensing strip, as well as a key fob having a fob body, a speaker, and an LED light.

The weight sensing pad is configured to determine if a child is present in the car seat or not depending on whether a predetermined threshold of weight is sensed at a given moment. The temperature sensing pad is configured to determine the temperature of the surface of the car seat where a child's back would touch depending at a given moment. The temperature sensing strip is configured to sense the ambient temperature in the vehicle at a given moment.

When it is determined that a child is present in the car seat and the temperature is in a unsafe range, an alarm signal is transmitted to the key fob and to the vehicle alarm system. This causes both the key fob to generate a audible alarm and a flashing light and the vehicle alarm system to go off until no child is sensed in the car seat.

It is an object of this invention to provide an integrated child car seat alarm would alert a caregiver if a child is left in a car seat through a key fob.

It is another object of this invention to provide an integrated car seat alarm having temperature and weight sensors to determine when a child had been left in a car seat.

It is yet another object of this invention to provide an integrated car seat alarm which is integrated with the vehicle alarm system to be able to alert anyone in the vicinity of a child stuck in a car seat of a hot car.

These and other objects will be apparent to one of skill in the art.

### BRIEF DESCRIPTION OF THE DRAWINGS

FIG. 1 is a front perspective view of a child car seat having an integrated car seat alarm built in accordance with the present invention.

FIG. 2 is a front elevational view of key fob of an integrated car seat alarm system built in accordance with the present invention.

### DETAILED DESCRIPTION OF THE INVENTION

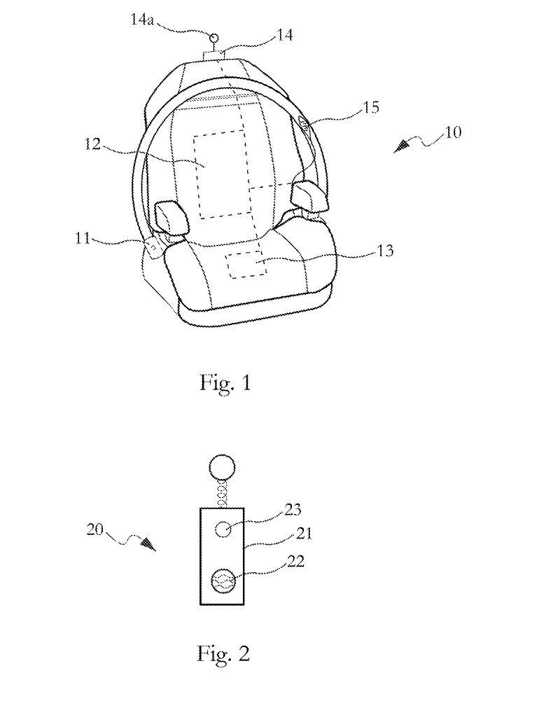

Referring now to the drawings and in particular FIG. 1, a car seat 10 having an integrated car seat alarm is shown as a base car seat 11 having a temperature sensing pad 12, a weight sensing pad 13, a transceiver assembly 14, and a temperature sensing strip 15. The weight sensing pad 13, temperature sensing pad 12, and the temperature sensing strip 15 are electrically connected to the transceiver assembly 14 and configured to transmit status information to the transceiver assembly 14 and receive electrical power from the transceiver assembly 14. The transceiver assembly 14 additionally includes a processor, memory, a bus and an internal power supply, defined in the preferred embodiment as a battery, to supply electrical power to its components and the weight sensing pad 13, temperature sensing pad 12, and the temperature sensing strip 15.

The weight sensing pad 13 is configured to transmit status information defined as either a child present signal or no child present signal depending on whether a predetermined threshold of weight is sensed at a given moment. In the preferred embodiment, the predetermined threshold of weight is the minimum child weight for the car seat in which the integrated car seat alarm is included. The temperature sensing pad 12 is configured to transmit status information defined as either a pad under temperature threshold or a pad over temperature threshold signal, depending on whether a predetermined temperature threshold is sensed at a given moment. In the preferred embodiment, the predetermined temperature threshold for the temperature sensing pad 12 is 105 degrees Fahrenheit. The temperature sensing strip 15 is configured to transmit status information defined as either a strip under temperature threshold or a strip over temperature threshold signal, depending on whether a predetermined temperature threshold is sensed at a given moment. In the preferred embodiment, the predetermined temperature threshold for the temperature sensing strip 15 is 120 degrees Fahrenheit. It is contemplated that the temperature sensing pad 12 is primarily directed at sensing the body temperature of a child in a car seat, while the temperature sensing strip 15 is primarily directed at sensing the ambient temperature in the vehicle. As such, they have different thresholds in the preferred embodiment.

When the transceiver assembly 14 receives status information of at least a child present signal and either a pad over temperature threshold signal or a strip over temperature threshold signal, it causes an integrated antenna 14a to transmit an alarm signal. In one embodiment, this alarm signal is at least sent to a key fob built in accordance with the present invention. In the preferred embodiment, this alarm signal is additionally sent to the vehicle alarm system, causing the vehicle alarm system to go off. In each embodiment, the alarm signal is continually sent until a no child present signal is received by the transceiver assembly 14.

Referring now to FIGS. 1 and 2, a key fob 20 is shown having a fob body 21, a speaker 22, and an LED light 23. The key fob 20 additionally includes an internal antenna to receive alarm signal transmissions from the transceiver assembly 14 and an internal power source, defined in the preferred embodiment as a battery, configured to supply electrical power to the antenna, speaker 22 and light 23. When an alarm signal is received from the transceiver assembly 14, the speaker 22 generates a audible alarm and the light 23 flashes until the alarm signal stops.

In an alternate embodiment, the key fob 20 additionally includes an internal vibrator configured to cause the key fob 20 to vibrate in addition to generating the audible alarm and light flashing when an alarm signal is received from the transceiver assembly.

In one embodiment, the weigh and temperature sensor pads are constructed of a thin pad made of polyurethane.

In one embodiment, the integrated car seat alarm system includes two key fobs.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. An integrated car seat alarm system, comprising:
a base car seat having a temperature sensing pad, a weight sensing pad, and a transceiver assembly integrated therewith, wherein said transceiver assembly includes an antenna and a power supply and is configured to transmit an alarm signal in response to stimuli from the temperature sensing pad and weight sensing pad; and
a key fob having a fob body, a speaker, an LED light, an internal antenna to receive alarm signal transmissions from the transceiver assembly, and an internal power source, wherein the key fob is configured to cause an audible alarm to be generated and the LED light to flash when the alarm signal is received from the transceiver assembly.

2. The integrated car seat alarm system of claim 1, wherein said temperature sensing pad, weight sensing pad, and transceiver assembly are electrically connected to enable the transceiver assembly to provide electrical power to the temperature sensing pad and weight sensing pad and receive status information signals from the temperature sensing pad and weight sensing pad.

3. The integrated car seat alarm system of claim 1, wherein said weight sensing pad is configured to transmit status information defined as either a child present signal or no child present signal depending on whether a predetermined threshold of weight is sensed at that moment and said temperature sensing pad is configured to transmit status information defined as either a pad under temperature threshold or a pad over temperature threshold signal depending on whether a predetermined temperature threshold of 105 degrees Fahrenheit is sensed at that moment.

4. The integrated car seat alarm system of claim 3, wherein said transceiver assembly is configured to transmit the alarm signal upon receipt of the child present signal and the pad over temperature threshold signal.

5. The integrated car seat alarm system of claim 4, wherein said transceiver assembly is additionally configured to transmit the alarm signal to an alarm system integrated into a vehicle.

6. The integrated car seat alarm system of claim 4, wherein said base car seat additionally includes a temperature sensing strip electrically connected to said transceiver assembly to enable the transceiver assembly to provide electrical power to the temperature sensing strip and receive status information signals from the temperature sensing strip.

7. The integrated car seat alarm system of claim 6, wherein said temperature sensing strip is configured to transmit status information defined as either a strip under temperature threshold or a strip over temperature threshold signal, depending on whether a predetermined temperature threshold of 120 degrees Fahrenheit is sensed at that moment.

8. The integrated car seat alarm system of claim 7, wherein said transceiver assembly is additionally configured to transmit the alarm signal upon receipt of the child present signal and the strip over temperature threshold signal.

9. An integrated car seat alarm system, comprising:
a base car seat having a temperature sensing strip, a weight sensing pad, and a transceiver assembly integrated therewith, wherein said transceiver assembly includes an antenna and a power supply and is configured to transmit an alarm signal in response to stimuli from the temperature sensing pad and weight sensing pad; and
a key fob having a fob body, a speaker, an LED light, an internal antenna to receive alarm signal transmissions from the transceiver assembly, and an internal power source, wherein the key fob is configured to cause an audible alarm to be generated and the LED light to flash when the alarm signal is received from the transceiver assembly.

10. The integrated car seat alarm system of claim 9, wherein said temperature sensing strip, weight sensing pad, and transceiver assembly are electrically connected to enable the transceiver assembly to provide electrical power to the temperature sensing strip and weight sensing pad and receive status information signals from the temperature sensing strip and weight sensing pad.

11. The integrated car seat alarm system of claim 9, wherein said weight sensing pad is configured to transmit status information defined as either a child present signal or no child present signal depending on whether a predetermined threshold of weight is sensed at that moment and said temperature sensing strip is configured to transmit status information defined as either a strip under temperature threshold or a strip over temperature threshold signal, depending on whether a predetermined temperature threshold of 120 degrees Fahrenheit is sensed at that moment.

12. The integrated car seat alarm system of claim 11, wherein said transceiver assembly is configured to transmit the alarm signal upon receipt of the child present signal and the strip over temperature threshold signal.

13. The integrated car seat alarm system of claim 12, wherein said transceiver assembly is additionally configured to transmit the alarm signal to an alarm system integrated into a vehicle.

14. The integrated car seat alarm system of claim 12, wherein said base car seat additionally includes a temperature sensing pad electrically connected to said transceiver assembly to enable the transceiver assembly to provide electrical power to the temperature sensing pad and receive status information signals from the temperature sensing pad.

15. The integrated car seat alarm system of claim 14, wherein said temperature sensing pad is configured to transmit status information defined as either a pad under temperature threshold or a pad over temperature threshold signal depending on whether a predetermined temperature threshold of 105 degrees Fahrenheit is sensed at that moment.

16. The integrated car seat alarm system of claim 15, wherein said transceiver assembly is additionally configured to transmit the alarm signal upon receipt of the child present signal and the pad over temperature threshold signal.
